(19) United States
(12) Patent Application Publication
(10) Pub. No.: US 2017/0011327 A1
(43) Pub. Date: Jan. 12, 2017

(54) METHOD OF COMPUTING AN ESTIMATED QUEUING DELAY

(71) Applicant: Spotted, Inc., Palo Alto, CA (US)

(72) Inventors: Milind S. Mantri, Fremont, CA (US); Haider Jainuddin Lasne, Palo Alto, CA (US)

(73) Assignee: SPOTTED, INC, Palo Alto, CA (US)

(21) Appl. No.: 14/797,164

(22) Filed: Jul. 12, 2015

(51) Int. Cl. G06Q 10/06

(52) U.S. Cl. CPC G06Q 10/063114

(57) ABSTRACT

A method of computing an estimated queuing delay is described that uses both historical queue delay data in the form of multiple calendar-based queue delay profiles and real-time data in the form of field-reports from service objects of actual queue delay. A decision selects either the source data from queue delay profiles or a real-time report. A clustering algorithm is used to assign potentially widely disparate geographic locations to clusters and to assign service type records to a cluster. Calendar-based queue delay profiles may be associated at the cluster level, at the service-type level, and at the individual service point level. Service objects may request an estimated queue delay; service objects may be provided with a estimated queue delay for a specified service point and also delays for alternative service points. Such requests may be prior to selecting or moving to a particular service queue.

### BACKGROUND OF THE INVENTION

As industrial and commercial processes become increasingly automated, autonomous and distributed, the optimization of the delivery of services becomes increasingly complex. The field of this invention is estimating queuing time delays for objects requiring services when there are multiple options for both the types of services and location of those services. In particular, one purpose and field of this invention is to generate an estimated queue delay for a particular service type at a particular location.

Queuing delays most generally may be broken into three components: (1) travel time or logistics time to get to the start of the queue; (2) waiting time in the queue, from the start of the queue to the end of the queue; (3) service time. In this invention we focus on estimating: (2) the waiting time in the queue, from the start of the queue to the end of the queue. However, the logistics delay to get to the start of the queue is an important consideration in several aspects of embodiments.

Prior art typically focuses on estimating this waiting time (2), starting from when the object requiring service gets to the start of the queue. An important distinction of embodiments herein over the prior art is that some queue delay estimates are computed at the start of (1); that is, prior to the time the object requiring service has reached the start of the queue.

It is important to note the possible confusion in text between the “start” and “end” of queues. For queues, the “start” is the point where the object requiring service first enters the queue; the “end” is the point at which the object requiring service exits the queue—typically then beginning the required service. Common usage for “lines” is the opposite. A person goes to the “end” of a line first, then moves up to the “start” of the line. It is important to use the context of the text to distinguish which usage of “start” and “end” is intended. Note also that in many cases in the text “requiring service” is interchangeable with “requesting service.” Note also that in many cases in the text “service location” is interchangeable with “service point.” Note also that in many cases in the text the term “object requiring service” is interchangeable with “service object.” Note also the terms “logistical delay” and “transit time delay” are sometimes, but not always, the same. In some case logistical delay may include more delay components than just transit time delay.

Prior art typically computes queue delays for only a single service type at a single location.

Prior art typically computes estimated queue delays considering only historical patterns, or computes estimated queue delays considering only real-time information, such as a number of people entering a supermarket, or speed of supermarket checkout transactions.

Prior art typically does not consider alternative locations, or alternative services.

Prior art does not use aggregation of historical data or historical patterns from many sources in computations of estimated queue delay. Thus, prior art is not able to estimate queue delays for a new service locations. In particular, prior art does not use clustering algorithms as an element in the computations to estimate queue delay.

Prior art does not associate multiple service types within one geographic area. Prior does not associate widely geographically dispersed service locations based on their historical queuing patterns.

Prior art does not automatically present to objects requiring service options alternative service locations, or alternative services at the same (or nearby) locations, or both.

Prior art does not provide automatic data forwarding of service choices made by objects requiring service, based on presented options, to service location queue management.

Prior art does not maintain historical queue delay patterns or profiles separately for days of the week, weeks of the month, months of the year, and around special events, or in combinations of these day/date/month/event times.

Prior art does combine historical queue delays for contiguous time intervals, nor split a time interval into two or move contiguous sub-times, for the purpose of conserving data or reducing compute time and improving estimated queue delay accuracy, respectively.

### SUMMARY OF THE INVENTION

Embodiments of this invention overcome the above and other weaknesses of prior art. In particular the following differences from prior art are used in embodiments of this invention:
both historical and real-time data are used in computing estimated queue delay times;
multiple, distinct service types with similar queuing profiles are aggregated using a clustering algorithm;
estimated queue delays are provided to objects prior to objects entering a queue, or prior to logistical delay to get to the start of a queue, allowing the objects options to not enter a queue or to enter a different queue;
estimated queue delays for a given service type at more than one service location are provided for use by objects in selecting a service location;
estimated queue delays at a given service location are provided for use by objects in selecting a service type;
historical queue profiles may be categorized and stored with unique hourly profiles by day of the week, week of the month, month of the year, or times around special events such as holidays or sporting events, or multiple categories, to provide more accurate queue delay estimates;
queue delay estimates are provided on request by objects considering but not committed to a service type and location;
queue delay estimates are provided with alternative locations for the same service type and alternative service type for the same service location;
queue delay estimates are provided for a time in the future that includes the travel time, logistical delay, or both, of the object requesting a queue delay estimate to enter the queue;
an algorithm to select whether to use historical data or real-time data in making a queue delay estimate considers both the statistics or patterns of the historical data and real-time data;
continuous queue profile time windows may be dynamically merged or split to consolidate historical data while also maintaining a sufficiently fine-grained set of time windows to accurately predict rapidly changing queue delays.

We first provide a simple scenario for one embodiment, without losing the scope or generality of other claims or embodiments.

Consider a city filled with vehicles; some are self-driving cars, some are human-driven, and some are commercial vehicles. These vehicles all require various services from time to time, such as gasoline, charging, oil-changes, passenger and package pickup and delivery, mechanical or cosmetic services, software updates, and the like. The city also provides a large number of places where such services are available. Some of these service locations have long queues of vehicles waiting to serviced; others have short queues. Queue lengths and queue delays often vary considerably over time, even from one 15-minute interval to the next. For a given vehicle at a given time, some service locations are farther away than others.

In addition, there is often allowable substitution of services. For example, one vehicle may prefer (that is, its software or human controller may prefer) gasoline of one particular brand, but will accept gasoline of another brand. As another example, the order in which packages or people are dropped off may be changed.

In addition, it may be desirable to get service at a particular location—for example, a location close to both the current location of the vehicle and also close the location of the next stop of the vehicle.

Therefore, sometimes the type of service is more important than the location of the service provider; sometimes the location of the service is more important than the type of service available. Sometimes a service is desirable, but not mandatory. For example, a software update or an intermediate battery charge. Such a service may be chosen, but only if it is particularly convenient, such as being available at a nearby location with a short queue. Another example of an optional service is a random quality audit. As yet another example, a service such as cleaning may be delayed to another day, or skipped entirely.

In a preferred embodiment, the invention predicts and provides an estimated queue delay; that is, the time interval from when a service objects enters the queue (the “end of the line”) and the time the service object exits the queue, and, typically, begins the service for which the object was waiting. In some cases the phrase, “queue length” is used rather than “queue delay.” For some types of queues a length is equivalent to delay, because the delay is computable, or estimable, from the length, that is, the number of service objects in the queue. For example, if data packets are waiting to be transmitted, and the transmission rate is fixed, than the amount of data (e.g., bytes) in the queue size is an accurate measure of queue delay. In addition, the length of a queue may be easier to measure, easier to transmit (i.e., report), easier to compute, and may be an industry-standard form of queue measurement. In other types of queues, a queue length may be used because that is easy to measure and report, even though it is not an ideal, or even consistent, metric for queue delay. Therefore, in some embodiments the phrase, “queue length” has either the same meaning, or an equivalent meaning, and therefore is, for those embodiment, within the scope of any claim using the phrase, “queue delay.”

In one embodiment, when a service is requested specifying a type of service, the embodiment computes and delivers estimated queue delays for the requested service at multiple locations. When a service is requested specifying a service location, the embodiment computes and delivers estimated queue delays for multiple service types at that location.

An important benefit of embodiments over prior art, in computing estimated queue delay early (i.e., before the object requiring service has moved to the start of the queue) is that alternatives are then available for the object. For example, the same service from a different location or a different service type, or no service at all. An important benefit of embodiments over prior art is computing estimated queue delays for such alternatives, and then presenting these alternatives to the object requiring service.

Thus, more than one such estimated queue delay may be computed in response to a single request, for example, for the same service type at different location, or for different service types, all at a single location. In this embodiment, an object requesting service may choose a service type and location matching the original request, a different location for the requested service type, or a different service type at the requested location (or near by).

As one example, consider a warehouse that stocks a particular item in multiple locations, and also provide packaging services for that item in multiple locations. Conveyors, robots, or humans may transport one such item to one such packaging service. Some packaging service stations may, at one moment, have longer queues of items waiting to be packaged, while other packaging stations may have longer transit times.

Embodiments of this invention describe specific novel algorithms to compute and then estimate real-time queuing delays for a range of objects requiring a range of services with options (or requirements) for different services at different locations.

Embodiments use real-time reported queue delays at different service locations to maintain and build baseline queue profiles, and then use those baseline queue profiles in conjunction with other real-time data to compute estimated, future queue times for different services at different locations.

Such queue delay computations and estimations permits optimization over a larger total scope of distributed objects and service locations than prior art computation and optimization algorithms.

Prior art estimates queue delays by several methods. One method uses historical data to estimate current queue delays. Another method looks at the real-time data of service objects entering the queue, and estimates queue delay based on the number or type of objects, or type of service for those objects. We can generalize the methods of the first type as using historical data. We can generalize the methods of the second type as using real-time data. Methods using real-time data often consider details of the type of service and consider the length of time for that service. That is, they consider both the queuing time waiting for service to start, and also the time it takes to deliver the requested service. This model generally assumes that one service object is being service at a time, or there are a known number of service lanes, such as a number of airline agents or a number of supermarket checkout lanes.

A first weakness of this prior art is that it uses either historical data or real-time data, but not both. A second weakness is that estimated queue delays are provided only after an object has entered a queue. Estimated queue delays are not computed sufficiently far in advance that service objects—given an estimated wait time—have an option of not entering the queue at all. A third weakness is that only a single service type at a single location is considered.

Yet another weakness of the prior art is the limited statistical models used to summarize historical data. For example, typically data from only a single service type at a single location is recorded and summarized.

A key embodiment of this invention computes estimated future queuing delays for specific services at specific locations. By “future” queuing delays, in this example, we may be referring to times 5 minutes to 20 minutes after the current time. For example, the estimated queuing delay for a vehicle if the vehicle were to now start driving to that service location. Thus, a novelty of this embodiment is providing estimated queue delays before the object requesting service enters the queue.

One embodiment creates “geographic service groups” to describe groups of services within a specified or predetermined distance of each other. For example, three gas stations at three corners of an intersection might be a “geographic service groups.” As another example, in a large warehouse, there may be 10 stations of people who package items for shipping. There are also another 10 similar stations on the opposite side of the warehouse. In this example, each group of 10 packaging stations is one geographic service group.

Services are also identified by service type. For example, a location to pick up passengers for ride services is one type of service, while a gas station is another type.

Service types may be hierarchical. For example, a higher-level might be “Shipping Stations” and there are sub-levels of “UPS,” “US Mail,” “Truck Freight,” “Dangerous Goods,” “Drone Shipping,” “Gift Wrapping,” and the like. There may be more than one level of hierarchy. Hierarchies may not be strictly tree structured. For example, under a high level of “restaurants” there may be one sub-level of price and another parallel sub-level of cuisine.

The demand for some service types varies substantially by time of day, day of week, week of the month, month of the year, or near a special event, such as a holiday or a sporting event. For example, commuters want ride services early in the morning. As another example, more items in a warehouse require gift-wrapping prior to holidays. Also, as it turns out, buyers for items ordered late in the evening more often request gift-wrapping.

Therefore, a core embodiment generates “baseline queue profiles.” Baseline queue profiles may be thought of as the best estimate for queue delays using historical data. A simple queue profile might comprise mean queue delay and queue delay variance for each of the 24 hours in a day. A more sophisticated profile might include one such 24-hour profile for each day of the week. An even more sophisticated profile might include one such 24-hour profile for each week of the month. An even more sophisticated profile might include one such 24-hour profile for each month of the year. An even more sophisticated profile might include one such 24-hour profile for days before, during and after major events, such as holidays or sporting events. These multiple calendar sub-profiles may be consolidated by storing only differences or variations between the various sub-profiles. Variance may not be required in all embodiments. The mathematical definition of standard deviation is the square root of variance. Thus, for purposes, herein, due to the mathematical relationship, variance and standard deviation are considered conceptually equivalent; when one is used, the other is also claimed. Of course, practical implementation must keep such definitions and units of measure consistent.

Baseline queue profiles do not have to comprise fixed one-hour time windows. Some time windows may be merged, and some split. For example, the time from midnight to 5:00 am may be a single time window, while the times around noon may be broken into windows of 10 or 15 minutes.

Time windows may be substantially shorter or longer than one hour.

Embodiments of this invention dynamically merge time windows and split time windows in order to consolidate data while maintaining sufficient time resolution to effectively and accurately estimate queue delays for service points that have rapidly changing queue delays.

Ideally, every service point has an associated profile assigned to it. An important embodiment groups service points of the same type, but in different geographic areas, with one set of baseline service profiles. Some individual service points may also have unique “overriding” baseline service profiles that are used for that service point, instead of the shared baseline service profiles.

An important embodiment uses one or more clustering algorithms to create the shared baseline service profiles and their associated service point sets. Such a set of associated service points may be called a “cluster.” Such clustering, in this application, is novel.

Looking at the multi-dimensional space of the queuing history of multiple service points in multiple geo locations, these geo locations are clustered, where the service points in each geo location have a similar queue delay profile. Thus, each cluster comprises a set of geo location records. Within each geo location record is: (i) a geo location, (ii) a service type in that geo location, and (iii) a count of number of service points of that service type in that geo location. Typically each geo location in a cluster has multiple service types; in other words, multiple geo location records in one cluster comprise the same geo location. In some embodiments the service points in a cluster are the same service type or similar or related service types. In some embodiments a cluster may have apparently unrelated service types, although the fact that they are in the same cluster implies that they have similar queue profiles. In some cases, when a new service point is added to the system, a similar service type to the new service point may be used to assign that new service point a default baseline queue profile, until sufficient historical data is available from that new service point and a clustering algorithm is run again. At that time, a profile that is a better fit for that particular service point will be selected, by the clustering algorithm, for that service point, and the service point will be moved to a different cluster.

One advantage of this approach is that, typically, a large number of service points are in a single cluster. The types of services in one cluster may vary widely, or they may be all the same type. The critical factor, with respect to creating clusters, is that the queue delay profiles of the members of the cluster are similar. For example, eating donuts and filling a vehicle with gasoline are substantially different service types. However, if they share a similar queue profile, they may be in the same cluster. More commonly, each cluster comprises members of the same or related service types.

A baseline queue delay profile is a graph, chart, table, formula or algorithm that provides a mean, and optionally a variance, of queue delay over time. This baseline queue profile is a non-real-time “best guess” as to what the delay will be for a given service point by time of day, day of week, week of month, month of year, closeness to an event, and the like. The baseline queue profiles are updated regularly by observing real-time data and using it to improve the baseline queue profiles. The baseline queue profile is not, by itself, real-time data. Baseline queue profiles also provide metrics for service rates, which are used to estimate how rapidly queue delay will change. For example, a service that takes a few milliseconds, such as a wireless digital authorization, may be able to clear a large queue in a few seconds. Whereas, a charging station for electric cars, at 45 minutes per car, might take many hours to clear a queue. Note that prior art often considers “demand” a factor in computing estimated queue delays. Some embodiments are free of numerical demand as an element of computations. Demand may be the number of objects requesting, or soon to be requesting, service, at one or more service locations.

Other embodiments create baseline queue profiles for each hour of the day, day of the week, each week of the month, each month of the year, or associated with special events, or any combination. We refer to all such profiles as “calendar” profiles. Note that elsewhere we describe how some time elements within a calendar profile may be split or merged, and how some calendar profiles may be merged or dropped entirely. Some service types have queue delays that are a strong function of such calendar profiles. Any reference to “service-level baseline queue profiles” or “baseline queue profiles,” singular or plural, may or may not include one or more calendar profiles.

When more than one calendar baseline queue profile exists, they may be averaged or numerically combined (e.g., via weighting prior to averaging) based on each applicable calendar day. For example, to create an effective baseline queue profile for Monday, Jun. 8, 2015, an embodiment may average (with or without weighting) three baseline queue profiles: for Mondays, for the month of June, and for the second week of the month. Since that June 8 is not near a holiday or known nearby sporting event, the special events baseline queue profile is not used.

Note that as additional historical data is accumulated it may be processed in two ways. First, the data is added into the baseline queue profile assigned to the service location that generated the data. Suppose that 10 service points all shared a baseline queue profile we will call Q77, in cluster C3. As data from these 10 service points accumulates, it is all merged into Q77, providing an updated Q77 that is now based on a larger dataset. Second, the data may be used to rerun a clustering algorithm. As a result of that, it may be that five of the service points remain in Q77 but five others are now re-assigned to a different baseline queue profile, Q91, in cluster C12. Some embodiments process accumulating data the first way, some process it the second way, and some process it both ways. It is important to rerun a clustering algorithm periodically as service points come and go, and queue delays change over time. Clustering algorithms may be updated hourly, daily, bimonthly, monthly, quarterly, or at some other fixed or variable interval.

In addition, in this above example, two of the 10 service points have their own, individual baseline queue profiles. These individual baseline queue profiles are also updated with the new data.

Let us consider a few additional examples. Birthdays do not vary widely by day of week or week of month. They vary slightly by month of year. Therefore, services specifically related to birthdays might maintain a baseline queue profile for each month of the year, but would not need to maintain a baseline queue profile based on day of week or week of month. (Noting that many services that might also be associated with birthdays are inherently day of week sensitive, such as party rentals.) As another example, services associated with weddings, graduations and summer vacations are particularly month of year sensitive. As yet another example, financial services are often sensitive to week of the month. Of course, many retail, consumer and commuter services are highly sensitive to day of week. As yet another example, services associated with holidays are inherently sensitive to the calendar dates of those holidays, such as Mother's Day, Easter, Labor Day, and sports championships. As yet another example, queues for internet data packets may be longest in the evening, when many people are streaming movies. Queues for satellite data packets may be highly dependent on international sporting events, such as the Olympics.

Some embodiments determine whether or not to maintain calendar based baseline queue profiles by analyzing the accumulated queue delay data. If the mean and standard deviation do not vary beyond thresholds from one calendar unit to another, then that calendar type baseline queue profile may be dropped, ignored, merged, or deleted. Another reason to not use all four types of calendar baseline queue profiles is that there is insufficient data to create meaningful separate calendar baseline queue profiles.

Another core embodiment aggregates real-time data regarding queue lengths or queue delays. This real-time data may be generated in at least five ways. First, the objects themselves may report when they have arrived at a service point geographic area, or at the start of the queue, or within the queue, or at the end of the queue. They may report a count of objects in the queue or how long it takes their own object or other objects to move through the queue. Second, the service location may provide a real-time report of queue length or queue delay as a count or as time delay. Third, the service location identifies when a particular service object arrives. This third method may be automated or may be manual. Typically, a newly arriving service object goes to the start of the queue (end of the “line”); however, the service object may be treated preferentially, moving to a non-start location in the queue. Fourth, data may come from a third source, that is, other than the object itself or the service location. For example, a drone might monitor queue size or delay via video. Fifth, other objects may provide data that another particular object has arrived at the service location. This fifth alternative may be used when one “smart,” “high value” or “equipped” object is capable of identifying additional objects. For example, a high value item, such as a television or cell phone may be able to identify an accessory item such as a cable or case. A smart vehicle (such as one equipped with a license plate reader) may be able to identify a traditional vehicle (by reading its license plate, for example). In many cases, this method is not expensive because the high-value item already has some type of wireless or video capability, while the low-value, or accessory item has an RFID, wireless ID, or is visually identifiable, such a having a barcode, product name in text, or a human face. GPS, wireless radio (e.g., WiFi, Bluetooth), printed bar and 2D codes, RFID, text readers, vision-based recognition and face recognition are all possible technologies for such object recognition. All of the methods of this paragraph may be automatic, semi-automatic, or fully manual. More than one method may be used, in any combination.

Queue size is often measured as account of objects requesting service, such as number of vehicles, number of data packets, or number of people. In some instances, the queue delay is closely associated with the queue size in these counts. In other instances the queue delay is not directly proportional to the queue size in object counts. Examples of the first case may be data packets in a router or people waiting at a coffee shop. Examples of the second case may be people waiting for medical services or commuters in a road lane. Ideally, embodiments provide estimated queue delays in units of time. However, in many cases the real-time data may be in the form of a count of service objects in a queue. Thus, some embodiments convert such reported real-time data as counts into units of time. Such conversions may use baseline profiles for this purpose, or other data stored at the cluster level or at the individual service location level.

Alternatively, one wireless device may monitor the quantity of wireless traffic in a location to effectively estimate the number of objects in the queue. Alternatively, a RFID reader may determine the quantity of packages queued up for service in a warehouse by pinging RFID devices within range and counting the number of responses. Apps on consumer devices, such as cell phones and watches, or apps on embedded devices, such as in automobiles or thermostats, may also participate in such providing of real-time queue size or delay data.

In one embodiment, the most recent real-time report is used to provide estimated queue delay, until that report is replace by a more recent report, or the report ages-out Aging-out is sometimes described via a time-to-live (TTL) quantity. A TTL quantity for a service may be pre-determined for a service type, or may vary over time based on current queue delay or on data from the baseline queue profile.

In one embodiment, if the quantity and quality of the real-time reported data (queue delay) is higher than a threshold, then the real-time data is used to provide predicted queue delay. If neither the quantity nor quality of real-time data is sufficient (meets thresholds) then the baseline queue profile is used to provide predicted queue delay or queue length. Thresholds for quality of data consider both the statistical mean and the statistical variance of queue delay or queue length.

In some embodiments the real-time reports and the data from the baseline queue profile are combined, such as using an ageing-time related weighted average, to generate an estimated queue delay. For example, the more recent the real-time report, the higher its weight. A starting weight may be 100%, than as that report approaches its TTL, its weight decreases, finally reaching zero at the TTL.

In one embodiment, the formats of the baseline queue profiles are regularly updated. Consider an exemplary scenario where a first baseline queue profile comprises a single average queue delay for each hour of the day. That is, there are 24 scalars in the profile. However, after accumulating real-time data for many days, it is clear that the average queue delays in the middle of night are substantially the same for adjacent hours. That is, the queue delay between 2-3 AM is about the same as for 3-4 AM. Therefore, these two one-hour time periods may be merged into a new, longer time period of 2-4 AM. Consider that also the queue delays around noon are not only long, but also have a high variance. This one-hour time period may be then broken into four smaller sub-times, each fifteen minutes.

In the above embodiments, aggregated real-time data is used continually to both merge and subdivide time intervals in the baseline queue delay profiles. The advantage of larger time intervals is that more data is available for averaging and data storage is reduced. The advantage of smaller time intervals is that the data is more fine-grained and thus estimated queue delays are more accurate.

An important aspect of some embodiments is filtering of real-time reports. If a single real-time report is going to be used for the queue delay estimate, it is particularly important that the real-time report is valid. Factors that go into various filters include: distance of the service object from the service location; reported queue length or delay is inside or outside reasonable statistical variance from the baseline profile average (e.g., within 0.75, 1, 1.5 2. 2.5 or 3 standard deviations); reported queue length or delay is inside or outside reasonable variance from one or more other recently reported queue length or delays; number of times the service object has recently reported a queue length or delay; invalid authorization or authentication of the data, data source, or data path; and other factors. Filtering is typically pass or fail. That is, the report is either used or discarded. However, weighting may be used in place of a pass-fail filter. Weighting is particularly useful if there are a large number of real-time reports.

Any system that aggregates and uses large amounts of distributed data must consider the situation where some data is invalid. There are many causes of invalid data, including hackers, software bugs, obsolete or broken hardware, or simply incompatible interpretation of data. In one embodiment, input data is filtered with a quality test. One such quality test considers the number of real-time queue delay reports for a single location or for a single geographic location. If the number of reports is too high or too low, compared to thresholds, then the filter rejects that data. Another such quality test considers the numerical value of reported queue delays. If the numerical values are too high or too low, compared to thresholds, then the filter rejects that data. Another such quality test considers the distance between the source of the data and the location of service being reported. A weighting factor inversely related to or inversely proportional to that distance may be used. Thus, rather than accept or reject data as a binary decision, data may be weighted with reporting sources closer to the service location given more weight.

Yet another reason that filtering is particularly important is that many data sources may be making their own estimates, or relying on data that itself may not be reliable, or may be using indirect methods for estimation. For example, the number of RFID devices that respond to a query from a reader may be used to estimate queue size as a number of packages at a service point in a warehouse. However, some devices in the queue may not respond, and some devices respond that are not in the queue (for example, they may have already received service but have not left the location). Such less-than-perfect methods of estimating queue size and queue delays are well known in many different industries and situations, including digital network traffic, server request traffic (e.g., digital video streaming), and vehicle traffic at traffic lights, vehicle parking lots, airport check-in queues, and warehouse dock loading and unloading.

Actual queue size or queue delay, or estimates of queue size or queue delay may be a function of attributes of the service object, such as the size of the object; the complexity of the object; the number of separate sub-objects within an object; special processing requirements of the object; preferential status of the object; or ancillary objects to be processed at the same time. These “object attributes” are generally attributes that do not require a separate queue for service, but which may cause the objects in the queue to serviced out of order; that is, not in a strict first-come, first served order. Examples of objects that require special processing include items to be shipped that require special packaging, special markings (such as dangerous goods), or specific shipping methods or carriers. Another example of a service object that requires special processing is an individual in a wheelchair. Examples of ancillary objects to be processed at the same time include cables with a computer. Examples of a number of separate sub-objects in an object include 100 apples or 25 pounds of apples to be shipped in a single crate. Another example of a number of separate sub-objects includes a party of six for restaurant seating. Examples of preferential status of the objects are a perishable or refrigerated product, a product to be shipped by drone, or a preferred customer such as an airline VIP member. Another example of preferential object status is a high priority network packet.

A key element of this invention is the real-time nature of the estimated queuing delays. For each report received, that report “ages.” That is, starting from the time of the generation of the report, the effective time of the report, or the time the report is received, the age of the report increases. The report ages-out or becomes “stale.” One method of processing real-time reports is batch processing. That is, reports within a window of time, such as 1 minute, or 15 minutes, are processed as a group. Then, a new window of time is used. Such windows of time may overlap, be contiguous, or not contiguous. Such windows of time may vary in length, where such time window lengths may be based on length of queue, variability in queue delay, number of reports, or variability of reports. Another method processing real-time reports is to weight reports such that newer reports are given a higher weight an older reports are given a lower weight. This method provides a “moving, weighted average” for the queue delay estimate.

Filtering of real-time reports may include weighting, for example but no limited to: age of data; quality of data source; distance of data source from the location of the queue; number of other reports from the same source; variability (e.g., variance) of quantitative elements within reports; variability (e.g., variance) of quantitative elements within reports from the same source; number of received reports for a particular queue; transmittal media or format of report; and others. Multiple weightings may used; for example, a filter or weighting may be “time-based,” and also use filtering or weighting factors such as those identified above. Filtering may also include the use of “outliers” or “questionable” reports. Outliers are quantitative reports that fall outside of a range. For example, a quantitative element that is more than three sigma from a mean value be discarded as an outlier. An example of a questionable report is one that may be from a hacked or defective source. Another example of a questionable report is one that is received from too far a distance from the queue, or one that has been sent too often. Another example of a questionable report is one in which the time difference between the sending time of the report and the effective time of the report is too high.

In one embodiment, estimates of queue waiting times are first based on an associated baseline queue profile; then that profile is updated from real-time reports. The baseline queue profiles are updated from time to time, where the frequency of update may be less than the update rates of the estimates. For example, queue waiting times may be updated every 15 minutes, while baseline profiles are updated once a day, once a week, or once a month

Queue profiles are often divided into a set of contiguous time periods. For example, a day may be divided into 24, one-hour periods. However, queue delays may vary dramatically over the course of a day. Therefore, it is advantageous to vary the size of the time periods. For example, midnight to 4:00 am may be merged into a single time period. As another example, 4:00 to 5:00 pm may be divided into four 15-minute time periods. Such merging and dividing of time periods may be based on the total number of objects typically serviced in the applicable time periods; the typical length of the queue in the applicable time periods, or the variability of queue delay in the applicable time periods. For example, queue delays from 8:00 am to 9:00 may vary from zero to 150. The queue delay may be somewhat predictable. For example, Mondays may typically have the longest queues while Tuesdays have the shortest queues. In some case the queue delay is not predictable. For such highly variable-length queues, it is advantageous to use smaller time periods so as to provide more accurate queue-length estimates.

For each time period, typically a number of computations are performed to generate an estimated queue delay. These computations include a statistical mean, and typically at least one variance, and counting the quantity of set elements and the number of reports. Computations may also include a rate of change, deviation from a baseline profile and many other statistical and non-statistical measures and computations. In some embodiments, the number and type of computations are not limited in or by the claims.

Updates to baseline profiles may be done in nominal real-time, such as at the end of each day, based at least in part on data received that day. Or, they may be performed in non-real-time, such as every month, even though the profiles themselves are for daily units of time.

A key embodiment uses “clustering” algorithms, some of which are well known in the art, to identify service locations that have similar attributes. For example, consider analyzing queuing time for aircraft waiting to take off for all US airports. Out of 5000 airports, such a clustering algorithm will group airports similar queuing attributes into clusters. For each cluster, a “cluster profile” is created. This cluster profile, at least initially, will be the baseline profile for each airport in the cluster.

Clusters may be hierarchical. That is, there may be “master clusters,” “regular clusters,” and “sub-clusters.” For example, three master clusters might be major US airports, minor US commercial airports, and non-commercial airports. Regular clusters might differentiate between east coast airports and west-coast airports, because, for example, the time-zone difference will produce baseline queue profiles, at least if Coordinated Universal Time is used, rather than local time. There is no limit to the number of hierarchical cluster levels.

A cluster may comprise more than a single service type. For example, queuing delays for one type of service may correlate well with a different type of service. Consider a warehouse that has holiday gift-wrapping stations. The demand for this service may increase substantially near Christmas. Another service point within the warehouse may be processing items with a high-insured value. Because people also purchase jewelry around Christmas time, demand for this service may correlate with the gift-wrapping service, even though the service types are distinct. Thus, both service types may be in a single cluster and so may share the same or similar baseline profiles.

Some clustering algorithms are well known in the art. For example:

http://en.wikipedia.org/wiki/Canopy_clustering_algorithm

http://en.wikipedia.org/wiki/K-means_clustering

http://en.wikipedia.org/wiki/Cluster_analysis

Examples of queues include servicing centers at a warehouse, factory, assembly plant, distributor, break-bulk facility, military supply center, or repair depot. Other examples of queues are for traffic, such as airplanes waiting to take off; or vehicles waiting to cross a bridge, road location or tollbooth. Yet more examples of queues are waiting lines such as at a gas station, department store checkout, restaurant, museum, emergency room or doctor's office.

Baseline profiles may be by category, such as for all shipping stations in all warehouses; or may be by category within a geographical area, such as all shipping stations in a single warehouse; or may be for individual service points.

A typical baseline profile is structured as follows, although other structures may be used. First, each profile is associated with a cluster, service type, or individual service location. Each profile comprises a set of time periods, such as 24 time periods in a day, not necessarily each the same length. Time periods may or may not be continuous. Time periods when the service is unavailable (e.g., closed) may not be included in the profile. Within each time period is a set of metrics for that time period. The actual set varies by service type. A typical set of metrics may be a subset of the following: the mean waiting time, the statistical standard deviation of waiting times, mean and standard deviation of service time delay between consecutive queue objects, mean and standard deviation of actual service time for objects, characteristics of object attributes (such weight of objects or counts of sub-objects), and day of week.

Methods described to update or maintain baseline queue profiles for individual service points may also be used to update or maintain baseline queue profiles for service types—that is, all service point providing the same service type in a cluster, or for all service points in all clusters providing the same service type. Methods described to update or maintain baseline queue profiles for individual service points may also be used to update or maintain baseline queue profiles for clusters.

Baseline queue profiles may be assigned at the cluster level. That is, each cluster is assigned a single baseline queue profile for that cluster.

Baseline queue profiles may be assigned for one or more service types within each cluster.

Baseline queue profiles may be assigned for one or more service points in each cluster.

Initial service types may be provided by service types maintained by the US Department of Commerce, or most common services searched for in a search engine, or known service types within a business type, such as warehousing, hospitality, travel, personal care, manufacturing, distribution, food processing, and the like.

Initial locations for creating initial records may be zip codes, geographic population density data, neighborhoods, shopping centers, existing facilities such as factories, warehouses, hospitals, travel hubs, break-bulk terminals, and the like.

“Day of week” may refer to the traditional meaning of seven days Sunday through Saturday, are may refer herein to attributes such as holiday or non-holiday. Other metrics in the set may be today's or yesterday's weather (e.g., temperature or precipitation) or relationship to a season or holiday. For convenience we sometimes identify a weather-related baseline profile as one of the calendar baseline profiles (four others of which are described above).

We may refer to each of the five calendar baseline queue delay profiles as a metric. Or we may refer to data in each profile as metrics. For example, if there are 24 hours in a daily baseline profile, and for each hour there is both a mean and variance, that one baseline profile may be said to contain 48 individual metrics. Fewer metrics in a set is advantageous because it permits a larger number of real-time reports to be aggregated and requires less information to be collected, analyzed and stored. More metrics have the potential to more accurately estimate queue delay because the average is based on a larger set. Therefore, there is motivation to have the “right number” of metrics in a set. As part of the process of updating baseline profiles, metrics may be analyzed via sensitivity analysis or correlation to determined relevancy. For example, one metric may be unrelated to queue delay, and so may be dropped from the set. As another example, a first metric may be closely correlated to a second metric, and so may be dropped, with the second metric then taking on additional weight in estimation computation. New metrics may be added as they are determined to be helpful, or as the reporting system is able to detect and communicate such metrics.

For services, there is an important concept of “affiliates.” An affiliate is a service point that does its own reporting and typically is provided with additional information about service objects as they arrive. Affiliates status of service points may apply both to fully automated, partially automated or fully manual service points. As an example of an affiliate, consider a restaurant. The host or hostess, or seating software at the restaurant is provided with the names, photographs and party size of people headed towards the restaurant. The restaurant may then plan for these people to arrive, perhaps by reserving a table for them. Notification that the party has actually arrived at the queue may also be provided. The affiliate may provide preferred services to such a participating party, such as free valet parking, queue position preference, an “automatic” reservation, preferred seating, or food or drink upgrades. In addition, an important service of affiliates is providing real-time queue waiting time data back to the system or software of embodiments of this invention. Real-time queue delay data from the affiliate may be provide automatically, such as by tracking the number of electronic customer-waiting pagers in use, or the number of cell phone within local range.

Another example of an affiliate may be a manufacturing station at a factory. For example, a body painting station may provide real-time information on the number of auto-bodies waiting to be painted. At a large break-bulk facility, knowing in advance the number of pallets waiting to be loaded at a particular dock may be useful in assigning loading dock numbers to arriving empty trucks. Similarly, knowing the queue delay or real-time waiting time at a dock may be useful to direct bulk products to a less busy, lower-waiting time dock.

In general, a “non-affiliate” service point does not itself report queue waiting time; information about that service point is provided by the service objects themselves, or data from another source, such as an overhead scanner on a conveyer, or data from ERP software, or from an individual using personal electronics.

Data from an affiliate service location may or may not be more accurate or more timely than data from a non-affiliate. A key aspect of affiliate service location is the additional two-way communication between the affiliate and the system or software of an embodiment.

In some embodiments a quantitative attribute of the arriving service objects may be important. One example is weight or size of items to be boxed and shipped at a packing station. Another example is the party size of people arriving at a restaurant. One example of how this is important is so that the correct box size may be moved to the packing stating. Another example of how this is important is reserving the correct size table at the restaurant.

It may be advantageous in some embodiments for the service object to be recognized when it arrives at the service point. For example, a bar-code reader or RFID sensor may recognize an item at a packing station. As another example, a customer may be recognized at a restaurant by a host or hostess matching a provided photograph with a person, or a wireless device electronically recognizing a personal electronic device carried by the customer (e.g., Bluetooth ID, WiFi ID, or cellular ID).

A core embodiment is the transitioning from the use of historical data, that is, the baseline queue profiles, to the use of real-time data, for provided estimated queue delay. For many services, the use of real-time data is a more accurate predictor of queue delay. For example, consider a service where queue delay may vary from zero to 60 minutes over the course of a day. However, the actual delay is not well predicted by the baseline queue delay profiles. Consider that such a service point might be five minutes away from an object requesting such service. Knowing the queue delay “right now” is, in this example, a more accurate predictor of the estimated queue delay five minutes from now, than an average queue delay from the baseline queue delay provide. The average queue delay might be 12 minutes, for example.

On the other hand, consider a service where the average queue delay is 45 minutes, and the standard deviation is 10 minutes. The nearest service point is one hour away. The current queue delay is 12 minutes. By the time the object arrives at the service point, it is more likely that the queue delay will be within the historical average, within one or two standard deviations, than it will be the unusually short delay at the moment. Therefore, the provided estimated queue delay should be from the baseline queue profile, not from the real-time data.

Therefore, by comparing the real-time data for queue delay to the queue delay in the baseline profile queue profile, it is possible, in some embodiment to chose the higher quality (that is: more likely correct) source for the estimated queue delay: either the baseline queue profile or the real-time data.

A core method of deciding whether to use the baseline queue profile data or real-time data is to compare the current real-time data with the average (mean) and standard deviation of the baseline queue profile data. If the real-time data is more than one standard deviation away, for example, then the real-time data is used. Note that, in some embodiments, the time required for the requesting object to reach the service point is considered in the computation. The decision threshold (e.g., 0.5, 1.0, 1.5, or 2.0 standard deviations) may be adjusted based on actual performance of the embodiment. The goal is to provide the “most likely” estimated queue delay. The threshold for determining which source: the historical baseline queue delay profile or the real-time data, may depend, in part, on the particular service type or service location. Thus, “learning” an ideal threshold dependent on either service type or service location is, in one embodiment, a method of improving the accuracy of estimated queue delays. In general, a higher standard deviation in the baseline queue delay profile is indicative that the real-time data should be used. (That is, the threshold for selecting the real-time data shifts towards selecting the real-time data.) This is because a high standard deviation suggests that historical queue delays are not a good predictor. On the other hand, a low standard deviation in the baseline queue profile is indicative that the baseline queue profile data should be used, because the current real-time data may be an anomaly. Note, of course that if the transport delay for the object requesting service to the service point is zero, or close to zero, then naturally the real-time data should be used.

Note that the threshold for selecting either the baseline queue profile data or real-time data is very much a function of the transport or logistics time for the object requesting service to the service point, for some embodiments. In general, the longer the transport time, with respect to the mean and standard deviation, the more likely the baseline queue delay information will be the most accurate source of the estimation. Similarly, the shorter the transport time, with respect to the mean and standard deviation, the more likely the real-time information will be the most accurate source of the estimation.

A core embodiment determines whether to use real-time data or a baseline queue profile when providing an estimated queue delay. One selection criteria is based on a mean delay. If a real-time reported queue delay is outside of threshold range from the baseline queue profile mean, then the real-time delay should be used. Such a threshold is typically measured using a variance, not a percentage or a time. For example, a mean that is more than one standard deviation away from the baseline profile mean suggests that, for the moment, the real-time data is a better estimate.

Another selection criteria is when the variance exceeds a threshold. For example, a baseline queue profile may show a standard deviation variance of 10 minutes. However, the real-time data for a service point shows that the recent queue delay variance is 30 minutes. This suggests that the real-time data is likely a better estimate.

Although the mean and variance thresholds used for selection of baseline queue profile data or real-time data as a source for queue delay estimates may be initially fixed, over time, some embodiments will regularly adjust the selection criteria to improve them. Note that the purpose of embodiments is to provide an estimate of future queue delay. Even if the object requesting service is just entering the end of a queue, the estimate is still only an estimate. Actual queue delay may be different. Thus, a large amount of historical data is available to system. The system, in some embodiments, may retroactively consider alternative selection criteria, then, by considering the actual queue delays that occurred, determine which selection criteria would have been optimal. In this way, for different clusters, for different service types, for different geographic regions, selection criteria may be tuned via retroactive analysis. One method of evaluating selection criteria is a least squares fit, where the data is the error between the provided estimate of delay and the actual delay. Selection criteria may be selected that minimize this error. Another selection criteria is least total error.

In some embodiments, the software of system of this invention may be linked via an electronic communication to existing software. For example, in a warehouse, existing ERP software may be linked. As another example, seating software or bill-printing software at a restaurant may be linked. Such linking may provide advance information. For example, if a UPS truck is due to arrive at a dock in five minutes, a longer queue may be appropriate at that dock. As another example, if a table of six people at a restaurant has just received their bill, it is reasonable to expect that table to become available shortly. In both of these examples, the real-time queue waiting time may be known in advance that it will change significantly, and then such expected change will then be reflected in the provided estimated queue waiting times.

Applications of embodiments vary from the completely physical, such as vehicle's needs to fill its gas tank or to recharge its batteries, to purely electronic, such as data transactions that move from one server or router to another, each of which provides some required or optional service. Such services might include customer identification, payment authorization, inventory confirmation, delivery booking, updated web pages, sending emails, generated log file or transaction file records, data backup options, audit options, user feedback options, user or server authentication, receipt generation, or optional recommended products. In some instances, applications may be a mix of physical activity and electronic data, such as where a patient might be able to have an x-ray taken, or a vaccine given, with minimal waiting time. Applications include personal services, including medicine, food, finance, and transportation. Applications also include all types of goods packaging, movement, value-add, labeling, distribution and delivery. Computers and software may be used, including servers, consumer electronic devices, portable and mobile electronics, embedded electronics, and apps. Embodiments may work with, under, over, or connected to existing applications, such as point-of-sale terminals, dashboard displays, public kiosks, and many other types of electronic equipment and user interfaces.

Queue delays are not abstract. An example of a queue delay is the length of time a person stands in line to get service at a post office counter. Another example is how long it takes a pending electronic credit card validation request to receive a positive or negative validation. Yet another example is how long a DNA sample taken at a crime scene must wait for a lab report. Yet another example is how long a package in a warehouse must wait prior to being gift-wrapped. Yet another example is how long a commercial airplane must wait on a taxiway prior to clearance for takeoff.

### BRIEF DESCRIPTION OF THE DRAWINGS

FIG. 1 shows a portion of an exemplary service point table.

FIG. 2 shows three geographic regions each with a corresponding service point table.

FIG. 3 shows a portion of an exemplary cluster table with the geography grouping and corresponding service type and counts.

FIG. 4 shows three clusters, each with a corresponding simplified cluster table and simplified geography mapping table.

FIG. 5 shows an exemplary 24-hour service profile.

FIG. 6 shows three clusters, each with a corresponding service profile.

FIG. 7 shows an exemplary diagram of data and messages between service objects, a server and a service point.

FIG. 8 shows an exemplary flowchart for deciding between a service profile and a reported queue delay for estimating a new queue delay.

FIG. 9 is an exemplary table showing different baseline queue delay profiles for different clusters.

FIG. 10 is an exemplary table showing grouping of different calendar profiles into baseline profiles and corresponding weights.

FIG. 11 is an exemplary table showing categories of service types.

FIG. 12 is an exemplary table showing geo locations assigned to clusters.

FIG. 13 is an exemplary table showing geo location information.

FIG. 14 is an exemplary table showing an hour of day calendar baseline queue delay profile.

### DETAILED DESCRIPTION

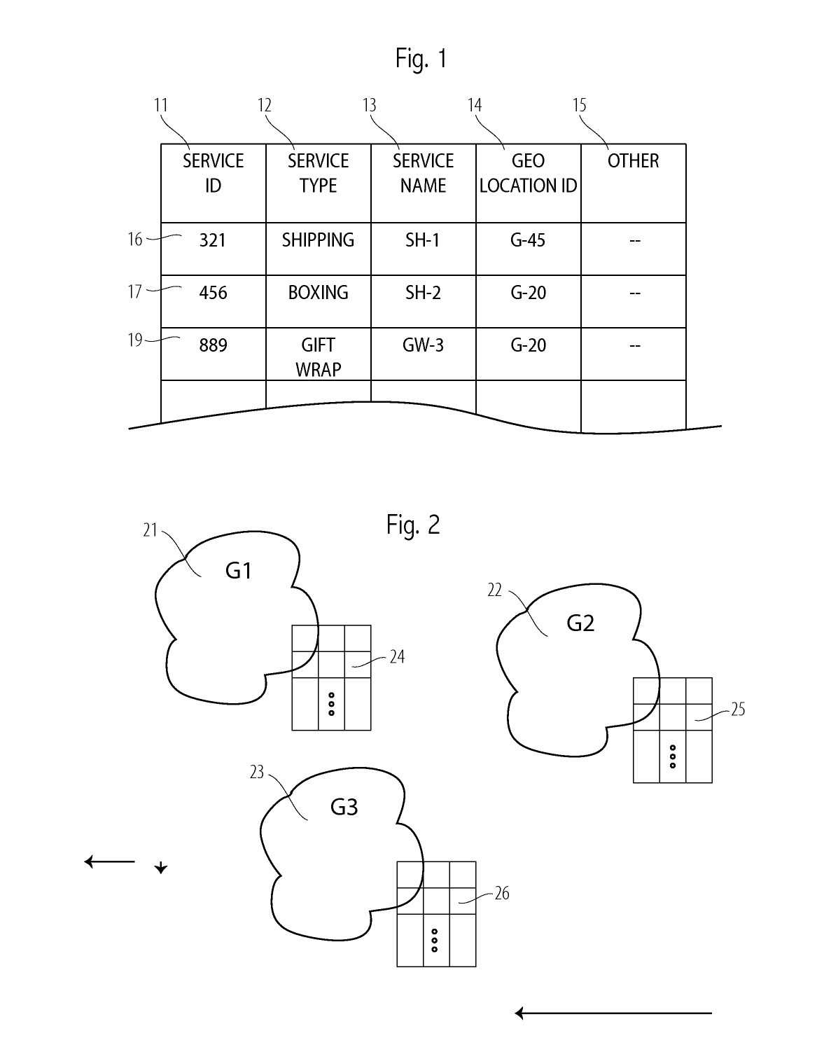

Turning now to FIG. 1, we see a portion of a simplified geographic service point table with three service points shown. Typically, there is one such table for each geographic region. For example, this table might be for geographic region G1, shown as 21 in FIG. 2. The columns in the table are 11 through 15. The three service points shown are in rows are 16, 17, and 18. The service ID, 11, is a unique identifier for the service point in that row. Each service point, shown as one row, is one location that is able to deliver one type of service. Column 12 shows the service type for each service point. For example, service point 321 in row 16 has a service type of “shipping.” Column 13 shows the service name for each service point. For example, service point 456 in row 17 has a service name of SH-2. The service name is not strictly required, and is typically for convenience and for reference to some other naming system. That is, the service ID is typically used within an embodiment, while the service name may be used in some other system, or it may be a common name. Column 14 shows which geo location the service point is in. Service locations may be assigned to geo locations either before or after a clustering algorithm is run.

FIG. 1 shows three service points as rows 16, 17, and 18. Note that each has unique service ID in column 11. Three service types are shown in column 12. Note that two of the service points, number 456 and 889 in rows 17 and 18, are assigned the same geo location ID: XY-20. Clusters typically include only a single service type. However, the subtypes of “boxing” and “gift wrap” are both sub-types of “shipping,” and so in this example, they may be in the same cluster.

Such a geographic service table as shown in FIG. 1 will be updated regularly, such as when new service points are added or deleted, or a clustering algorithm is rerun, which might reassign service points.

Column 15 shows that other attributes of service points will typically be in this table. In a real implementation, there are typically many more pieces of information recorded about a service point. Note that table in FIG. 1 is a logical table, which may be implemented in a large number of ways, as those trained in the art appreciate, such a relational data base, objects in an object oriented programming language, elements such XML entries in a server, and numerous other storage, structural and data formats.

Often, multiple service points, which may be the same service type or unrelated service types, are at each geographic location. Some geographic locations will only have one service point.

Service types may be hierarchical. Column 12 may actually be multiple columns, or multiple entries per row shown optional hierarchical elements. For example, a service type of “shipping” might include sub-service types of “boxing,” “gift wrap,” “labeling,” and the like. There may be multiple levels in a hierarchy, and the hierarchy may not be a strict tree. That is, one service point may have more than one designated subtype. For example, a restaurant service type might include subtypes of both “Italian” and “casual.”

Turning now to FIG. 2, we see a logical diagram showing three geographic regions, G1, G2, and G3, with reference designators 21, 22 and 23, respectively. Each geographic region has an associated geographic service point table, such as one shown partially in FIG. 1. The service point tables associated with each geographic region are shown as 24, 25 and 26, respectively, for regions G1, G2 and G3.

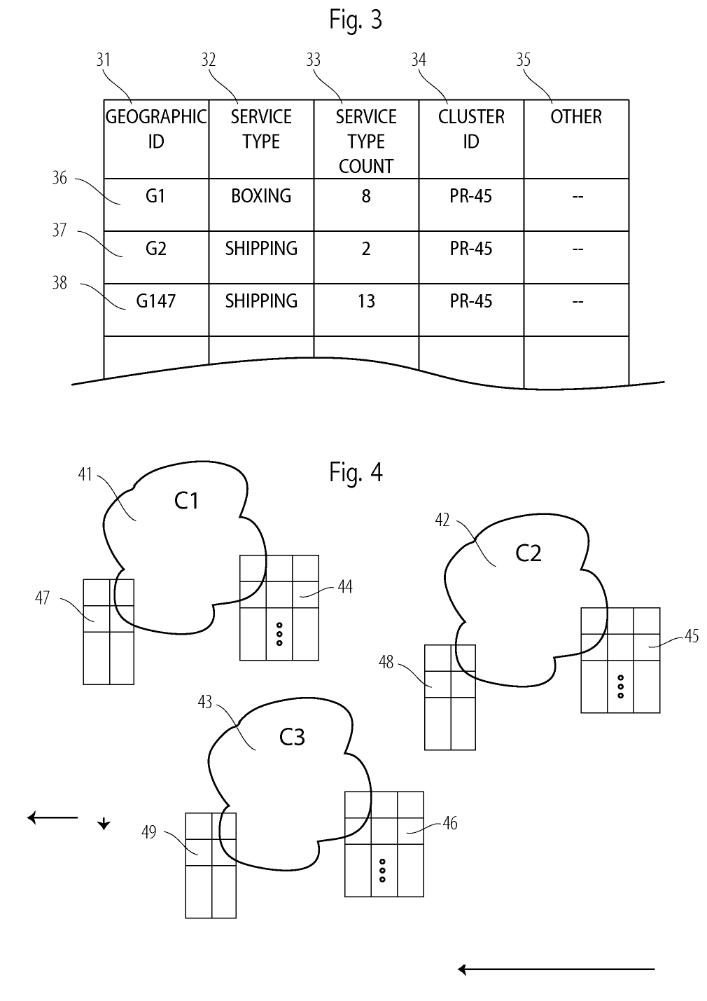

Turning now to FIG. 3, we see a portion of a simplified cluster table. A cluster table comprises entries for service types within a geographic location. A single cluster table will often have only the same or related service types. However, in some embodiments, some clusters will have service types that are superficially unrelated. Note that the clustering algorithm groups service types within a geo location by similar baseline queue delay profiles. Thus, although some service types may appear to be unrelated, they share to some degree, similar baseline queue delay profiles. For each service type, the cluster table identifies the number of services of that type, at each geographic location that is in the cluster table. In addition—and core to the concept of clusters—is that the service baseline queue delay profile for every entry in the cluster table is similar. That is, the service profiles of those businesses “cluster” as being similar in shape. Baseline queue delay profile shapes are described elsewhere herein. Column 31 identifies the geographic area for that row entry. For example, rows 36 and 37 are for geographic areas G1 and G2, such as might be shown in FIG. 2. Row 38 is for geographic region G147. Column 32 is the service type for each row. Although a row in a cluster table is for a single service type, there are sub-service types and secondary service types that may be indicated, or have their own rows. For example, here, in row 36, there are 8 service points that provide “boxing,” which is a subservice type of shipping, which is the service type in this table in rows 37 and 38. Column 33, service type count, shows how many service points of this service type there are available for the geographic area shown in this table. For example, there are 13 service points of type “shipping” in the geographic area G147, as shown in row 38. Column 34 shows the cluster ID. Since each cluster table is for one cluster, the cluster ID for every row is PR45.

Column 35 shows that other attributes of rows. In a real implementation, there are typically many more pieces of information recorded about the service type rows. Note that partial table in FIG. 3 is a logical table, which may be implemented in a large number of ways, as those trained in the art appreciate, such a relational data base, objects in an object oriented programming language, elements such XML entries in a server, and numerous other storage, structural and data formats.

Such a cluster table as shown in FIG. 3 will be updated periodically. It will be updated for at least three major reasons: (1) A service point is taken out of service. In this case, the service type count in column 33 for the appropriate geographic area of the removed service point will be decremented. (2) A new service point is added, before a clustering algorithm is run. That new service point will be assigned to a cluster, based on its service type and other factors. This may be viewed as a “best guess” for the service profile of that new service point. (3) A clustering algorithm is re-run. Such a re-run may make zero, or a few, or a large number of reassignments of service points into clusters. As one example, it may be desirable to have fewer clusters or a larger number. In such cases, it can be expected there will be a large number of re-assignments. As another example, it may be desirable to run a different type of clustering algorithm, or to weight one of the dimensions in a clustering algorithm. In such as case, there may be a large number of re-assignments.

Turning now to FIG. 4, we see a logical diagram showing three clusters, C1, C2, and C3, with reference designators 41, 42 and 43, respectively. Each cluster has a cluster table, such as one shown partially in FIG. 3. The cluster tables associated with each cluster are shown as 44, 45 and 46, respectively, for regions C1, C2 and C3. Note that these clusters are very much logical groupings of service points because they have similar queue delay profiles. The various geographic areas may be, and often will be, spread out. For example, one such service type might “airport security delay.” The airports, or geographic regions, may be all over the country (or the world). Some geographic regions may have more than one airport. For example, in the San Francisco Bay area, there are three airports: San Francisco, San Jose, and Oakland. These three airports may well have similar queue delay profiles, and so all three might end up in the same cluster, in one geographic region. Thus all three airports would be on one line in a table such as shown in FIG. 3. In addition, there are two airports near Washington DC, Reagan Washington National and Dulles. These two airports might be on a separate, but single line in the cluster table. All five airports would share a similar queue delay profile for a security queue delay. Most likely some airports, such as a small airport near a tourist destination resort, such as Telluride, Colorado, will have a far different baseline queue delay profile that the major city airports mentioned above. Therefore, that airport will be in a different cluster.

In addition to a cluster table in each cluster, a preferred embodiment also has a geo location table in or associated with each cluster. These geo location tables are shown in FIGS. 4 as 47, 48, and 49 for clusters C1, C2 and C3, respectively. A geo location table may be a simple, single-column list of geo locations. Note that this table or list of geo locations should be consistent with the geo locations in the cluster table, such as shown partially in FIG. 3, above. The geo location table may be part of the cluster table, in some embodiments.

Clusters may or may not be hierarchical. For example, there may be three clusters, C11, C12 and C13. These three clusters may be “rolled up” into a cluster: C10. The higher-level cluster, in this example, C10, may be viewed as a “super cluster.” That is, thinking of a clustering algorithm for a moment, clusters themselves may cluster. Multiple levels of this cluster hierarchy are possible.

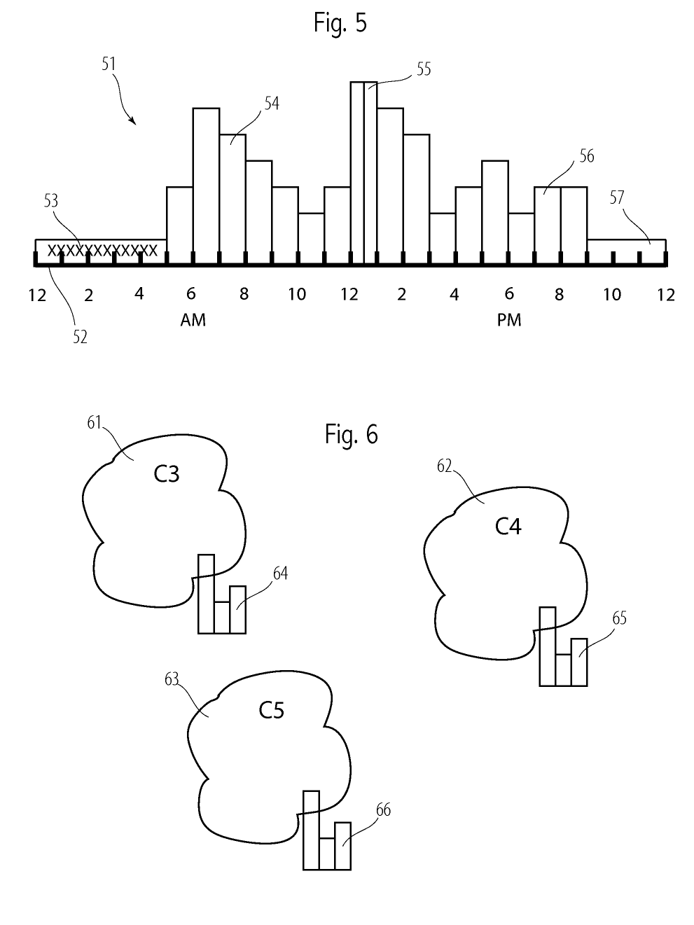

Turning now to FIG. 5, we see an exemplary queue delay profile over 24 hours, 51. Note that not all queue delay profiles will be organized as hours in a day, such as this one. Profiles may be over a very short time period. For example, packet queue delays in routers might be in units of milliseconds. As another example, the wait to get a cabin reservation at some summer camps is now over 10 years. The horizontal axis, 52, is time of day, in one-hour units, shown as from midnight to midnight. The vertical axis, the height of the bars (such as 53, 54, 55, 56 and 57) is unit of wait time, or, in some cases, a throughput measure, such as dollars per minute, customer per hour, tons per day, or containers unloaded per ship, in some cases a queue length count, such as people, vehicles, or packets.

Although the major increment of time in the queue delay profile, 51, is one hour, important embodiments merge adjacent time intervals, such as shown, 57, where the hours from 9:00 pm to midnight are merged into a single delay metric. Another important embodiment is the splitting of time intervals. For example, we in 55 that the hour from noon to 1:00 pm has been broken into two half-hour units.

54 shows the delay from 7:00 am to 8:00 am, as the height of the bar. Note that in the profile 51 that the average waiting time has a peak from 6:00 to 7:00 am, then steadily declines until 10:00 to 11:00 am. Then, we have a new peak from 12:00 noon to 1:00 pm, 55. 56 shows the delay from 7:00 to 8:00 pm, which is the same as from 8:00 to 9:00 pm. Since these two queue delays are about the same, these two hours may be candidates to combine. 57 shows three equal delay hours, from 9:00 pm through to midnight. These have been combined, as shown. Note that the height of the bars for 53 and 57 may be zero delay. A service point may be closed, for example, during these hours. The hours shown in 53 are marked with X's to show that the service point is not available during these hours.

A service point being unavailable, such being closed, are shown here in one example as the X′s in 53. Such information is important, as obviously one does not want to schedule an object needing service into a closed service point. Hours that a service point is closed or otherwise unavailable may be stored elsewhere, for example, in the service point records, such as line 19 in FIG. 1, in the “Other” column, 15.

Not shown in FIG. 5 is variance. Variance is important in some embodiments. Variance might be shown in the traditional way as range bars. Variance might be stored as a standard deviation. However, there are many other statistical methods that can be used to indicate variance, including time weighing of input statistics, and weighting shorter delays differently than longer delays.

Turning now to FIG. 6, we see a logical diagram showing three clusters, C3, C4, and C5, with reference designators 61, 62 and 63, respectively. Each cluster has a baseline queue delay, such as a profile shown partially in FIG. 5. These are called “baseline” queue delay profiles because each service point may have its own queue delay profile, which overrides the baseline profile. The baseline queue delay profiles are shown as 64, 65 and 66 for clusters C3, C4, and C5, respectively.

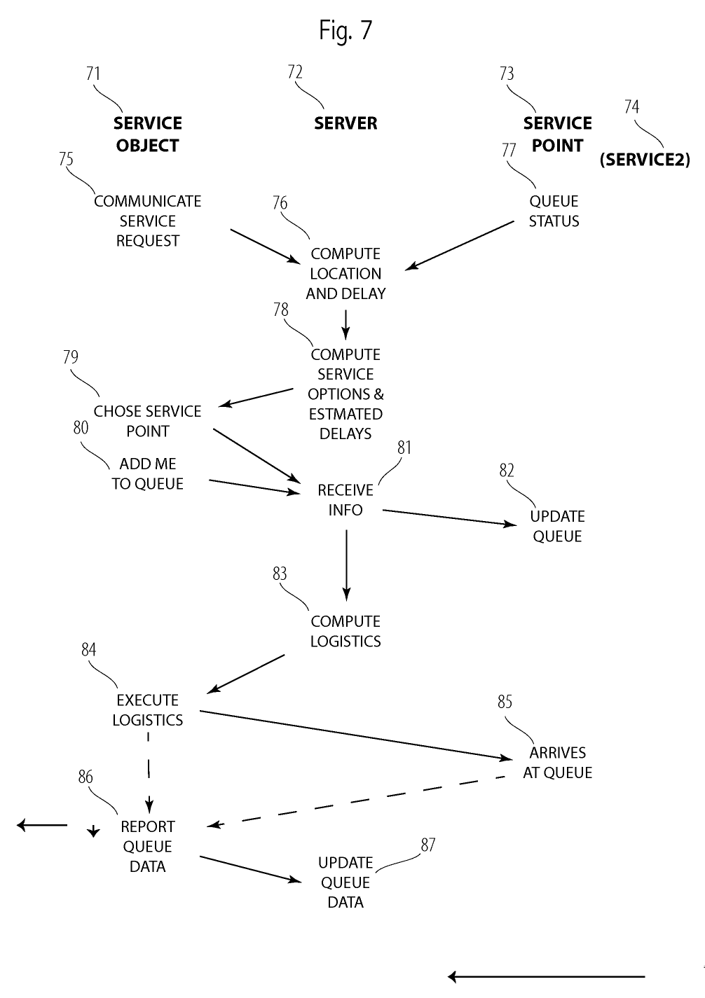

Turning now to FIG. 7, we an exemplary flow of information in one embodiment. In this Figure, time moves downward. Here the columns under “service object,” 71 and under “service point,” 73 represent a physical object (or group) and service location, respectively. The column under “server,” 72 might be a physical server, or any other logical, compute and storage location, including virtual or distributed such capabilities. Although this Figure shows a single service point under 73, in practice a large number of service points are participating, which is shown with a single additional service point, “service2,” 74, for which no details are shown in this Figure.

The service point provides its queue status, 77, to the server, from time to time. This information update may be asynchronous to the other actions or steps in this Figure. The service object, under 71, initiates this embodiment by communicating some nature of a service request in step 75. Such a service request may be either general or specific. For example, it may provide a range of possible services, or a single service type. It may provide a specific location or a geographic area. Many other requirements, alternatives or options may also be contained with this service request. In one embodiment, it is a request for a single service at a single location.

The server, in step 76, computes the locations and distance between the service object, under 71, and the service point, under 73. It also computes in this step any logistics delay, such as the service object moving to the service point. In step 78, the server optionally computes service options. Such options may be for the same service as the one requested, but at one or more different locations. It may also be for alternative services at the same location as the one requested. A core step in this invention is computing the estimated queuing delay, for the service object under 71 for the requested service, under 73. In addition, estimated queue delays for the alternatives, if any, are also computed. Note that core embodiments provide the estimated queue delay at the time that the service object will arrive at service point. The estimated queue delay does not include travel time or logistics delay in getting the service object to the service point, although clearly that delay could be computed, estimated, added, and communicated, if desired.

These one or more estimated queue delays are then communicated from step 78 to the service object. The service object under 71 then chooses a service point and thus effectively a service type in step 79. Such “choosing” may be automatic, manual, or a combination. Note, however, that in core embodiments this decision is made by the service object, based on the information provide by the server as shown in this Figure. The service object may choose none of the provided options, and may repeat a request from step 75. The selected service point is communicated to the server and received as step 81. The service object may also decide that it wishes to be added to the queue of the service point in step 80. Communication from this step 80 may be to the server, 81, or directly to the service point 82, or through the server 81 to 82. There are two options by the service point in how this “add me to queue” request by the service object is handled. One option is to reserve a place in the queue, as of the time of the request, 82. Another option is to simply note that the service object is expected to arrive and expected to join the queue, after the appropriate logistics or travel delay.

The next step, which is optional, is for the server to compute the logistics to move the service object to the selected service point. As two examples, such information might be instructions to conveyors in a warehouse, instructions to warehouse robots, delivery instructions to a third-party carrier, or may be travel instructions provided to an app on a mobile device associated with the service object.

No matter how the service object under 71 computes, guesses or receives logistics instructions, it needs to execute those logistics in step 84, which may well rely on third party services or automation. After step 84, the service object arrives at the service point, 85. The service object is added to the queue, either at the start, or at the location within the queue that was earlier reserved, such as in step 82.

Step 86 is optional, but is important in some embodiments. The service object under 71 reports the queue length or delay at the service point. This report might be when the object first arrives at the service point, or it may be after the service object has passed through the queue delay, or at some other time. This report is called a “real-time queue delay report,” and is important information in some embodiments in order that the server is able to provide more current and more accurate queue delay estimates based on this report. The server receives this updated queue delay, as reported by the service object, in step 87. Note that in some embodiments the service point provides real-time queue delay updates, such as shown in step 77. Dotted arrows are shown from steps 84 to 86 and 85 to 86 to show that both paths are ideally required prior to the service object reporting queue delay. That is, service objects should not report a queue delay if they do not know what the queue delay is. Therefore, they should arrive at the service point prior to reporting.

In some embodiments, the service point under 73 is passive. That is, it does not participate at all (or only some steps) shown under 73, in this Figure. In such an embodiment the flow is substantially the same as in this Figure, except that steps 77, 82 and 85 are left out.

Step 83 may be performed by the server, or by the service object, or elsewhere, or not computed at all. The service object may be able to get to the service point by itself, or with assistance from elements outside this Figure or outside of this embodiment. In some embodiments, it is already at the service point, so in effect, no logistics, step 84, are required.

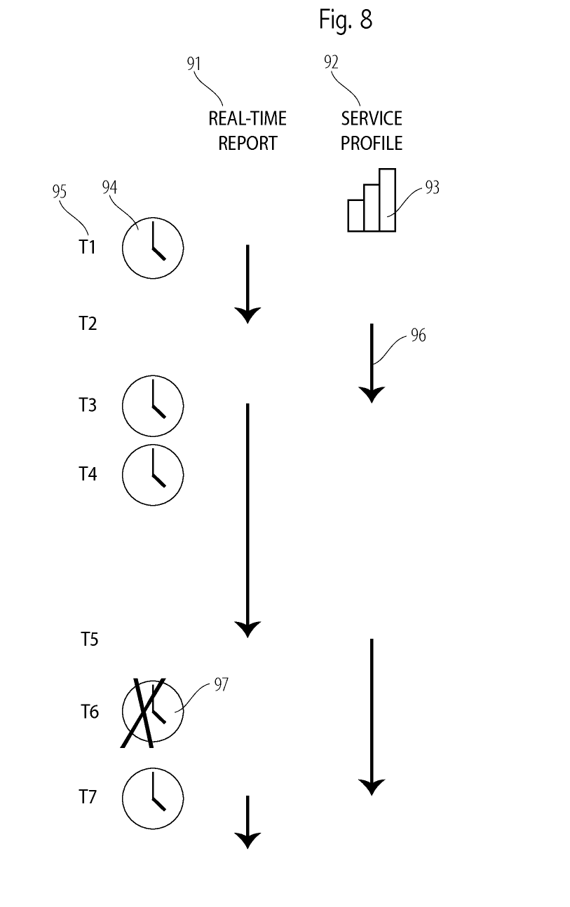

Turning now to FIG. 8, we see a series of decisions, by a server or equivalent, in one embodiment, of whether to use real-time queue delay reports or to use the average queue delays contained in one or more baseline queue delay profiles. Note that these queue delay estimates generally apply to one service at one service point. However, these steps may be extended into multiple services a multiple service points. In this Figure, time moves downward.

Real-time reports are used for providing estimated queue delays as shown by the arrows under 91, “real-time report.” Baseline queue delay service profiles are used for providing estimated queue delays as shown by the arrows under 92, “service profile.” Icon 93 is provided to assist in readability of the Figure. Times are shown in the column under 95, starting with T1.

At time T1 a real-time report, 94 is provided. This report is current, and so that triggers the selection of that report as the basis for queue delay estimates, as shown by the arrow under 91, just to the right of T1. At time T2, the real-time report has aged out. That is, too much time has passed between T1 and T2 for the last real-time report to be considered current. Thus, data from the service profile is used as the basis for queue delay estimates, as shown by the arrow, 96, under 92, just to the right of T2. At time T3 another real-time report is generated. Thus, again, that report is used as the basis for queue delay estimates, as shown by the arrow under 91, just to the right of T3. At time T4 another real-time report is generated. Real-time reports are still being used as the basis for queue delay estimates, however, now the report from time T4 is used, rather than the report from time T3. The queue delay reported at T4 may be either longer or shorter than the delay reported at time T3, but either way, the report at time T4 is more current, so it will be used. In other embodiments, other selection computations may be used, such as time-weighted averaging. Also, in some embodiments, an intermediate queue delay time may be computed that is between a real-time report and the average from the baseline queue profile. The weighting in this computation show weighting the real-time report more heavily based in its timeliness. During the time interval from T3 to T5 real-time reports are used—first the report form time T3 then the report from time T4. Note that this time interval from T4 to T5 is longer than from T1 to T2. This is because the “time out,” sometimes called “time to live,” or TTL, is longer after T4 than after T2. The TTL may be a constant, but is preferably computed based on the queue delay, the variance of the queue delay, the service type, and the frequency of real-time reports, as well as on other factors. At time T5, the report from T4 has timed out, and again queue delay estimates from the baseline service profile under 92 are used.

At time T6 another real-time report is received. However, this report does not pass a quality filter and so is not used, as shown by the X, in 97. Such filtering is important, and may include reasons such as corrupted or non-verifiable data; too far a distance between the service object reporting and the service point; an unknown report source; a report source that has made an excessive number of reports; or a reported queue delay time that is an “outlier,” meaning it is too high or too low to be trustworthy. Thus, service profile averages continue to be used as the basis for queue delay estimates, as shown by the arrow to the right of T6. At T7, another real-time report is received, and thus teal-time reports, using the time reported at T7, are used to provide estimates of queue delay, as shown by the arrow to the right of T7.

Note that we show individual clock icons at T1, T3, T4, T6 and T7, to show that these are individual real-time reports. We use a single icon, 93, to show that the service profile is a static data structure, at least for the duration of time shown in this Figure. Note that the times in that service profile will typically be different for different hours of the day, as shown previously in FIG. 5. The times shown T1 through T7 may be closely spaced, such as a few minutes apart, or may be spaced hours apart. For some applications, the time spacing could be far less or more. For high-speed data queues, such time intervals might be milliseconds or microseconds.

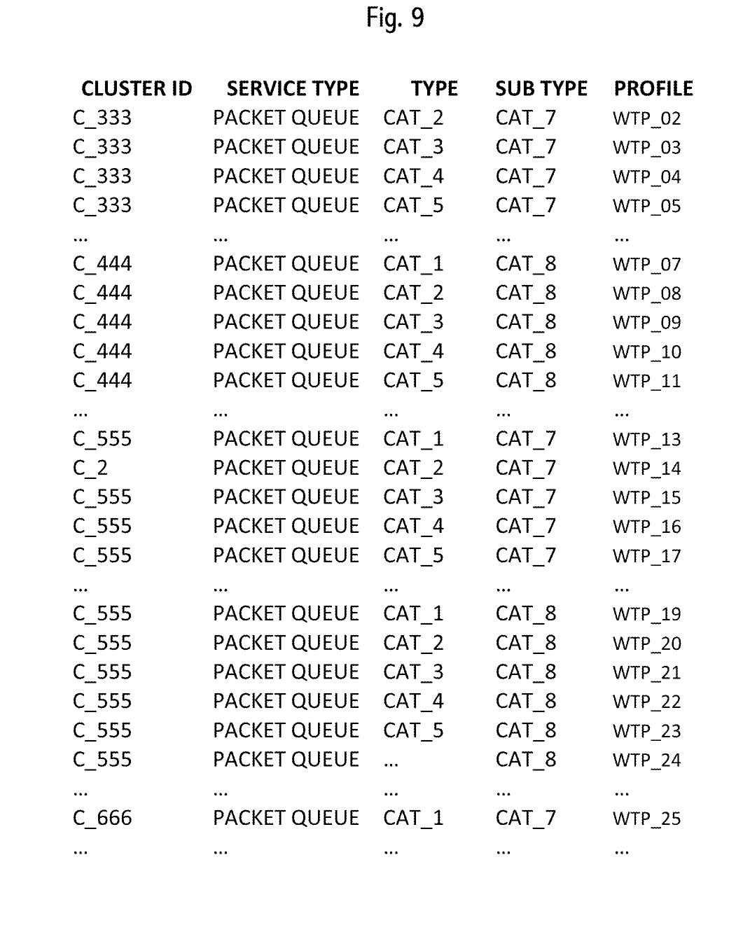

Turning now to FIG. 9, we see a partial, exemplary table showing different baseline queue delay profiles for different clusters. Rows and columns for this table, and for all tables in higher numbered Figures, are numbered traditionally for tables. That is, row 1 is the top row with column headers; column 1 is the left most column. Here, a single cluster, such as C_333 is shown comprising four different baseline queue delay profiles: WTP_02, WTP_03, WTP_04, and WTP_05 in rows 2 through 5 respectively. For each of these four different baseline queue delay profiles, the table also shows the type and sub-type of that baseline queue delay profiles, in columns 3 and 4 respectively. This table shows some exemplary entries of baseline queue delay profiles for clusters: C_333, C_444, C_555 and C_666. Note that there are two groups for cluster C_555, indicating that such a table may not be in any particular order, and may not be a flat table; for example, implementation may be in a relational data base, XML, or other data format and implementation. Note also that in row 14 the cluster ID is C_2, otherwise in a block of C_555. This is an example of how a particular baseline queue delay profile, here WTP_14, has been re-assigned into a new cluster following the running of a clustering algorithm. Three dot ellipses indicate additional rows, not shown. Column 1 shows the cluster ID; column 2 shows the service type for the particular baseline queue delay profile shown in column 5. In this partial, exemplary table, all service types are for data packet queues, such as might be found in a router, switch, firewall, or web server. Note that such a table in practice has additional columns for additional information about clusters and baseline queue delay profiles, as well as additional columns as needed for implementation, tracking, logging, auditing, error management, and the like. Also, such a table in practice has many additional rows to support many more clusters and baseline queue delay profiles.

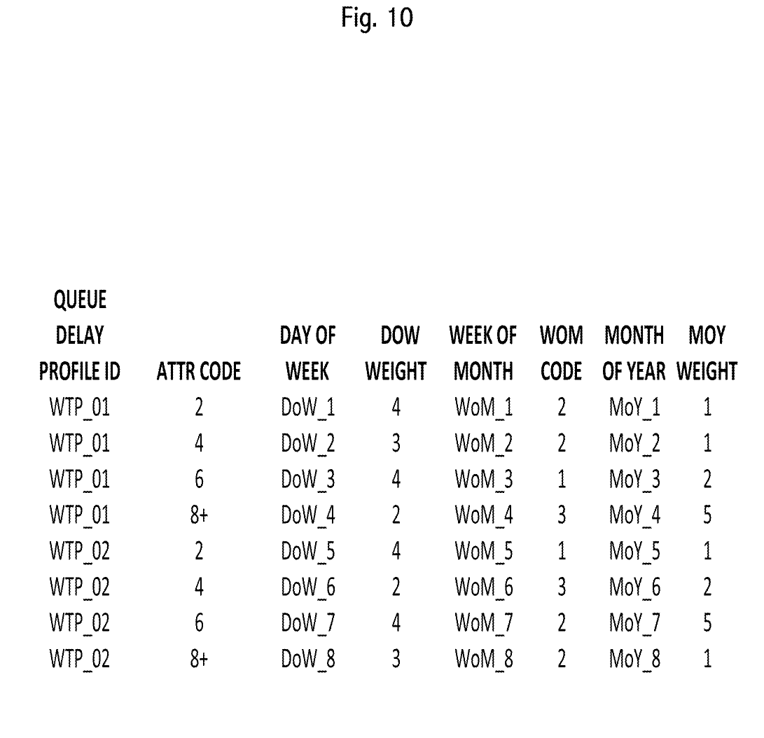

Turning now to FIG. 10, we see a partial, exemplary table showing the weights of different calendar profiles for two particular queue delay profile IDs. The queue delay profile IDs are shown in the first column. Data for two profile IDs are shown: for WTP_01 and WTP_02. The individual rows are multiple entries for a given queue delay profile ID in column 1, where the each entry also contains an attribute code in the second column. This is because within a single baseline queue delay profile there may be different attributes, where each attribute defines characteristic. For example, attribute codes may be the weight or weight range or weight class, or shipping class of a box to ship. It may be a priority code for a data packet. It may be a type of aircraft waiting to take off. It may be the number of people in a party seeking dinner in a restaurant. Columns 2 through 6 show different numerical weights associated with the various calendar profiles. This partial table shows only three calendar profiles: day of seek, week of month, and month of year, in columns 3, 5, and 7 respectively. As discussed elsewhere, there are optionally additional calendar profiles. Each calendar profile has an associated weight, which is used when created a weighted average to compute a queue delay profile for a specific queue delay profile ID and an attribute code. The associated weights are shown in columns 4, 6, and 8, respectively. Note that such a table in practice has additional columns for additional calendar profiles and their weights, as well as additional columns as needed for implementation, tracking, logging, auditing, error management, and the like. Also, such a table in practice has many additional rows to support many more queue delay profiles.

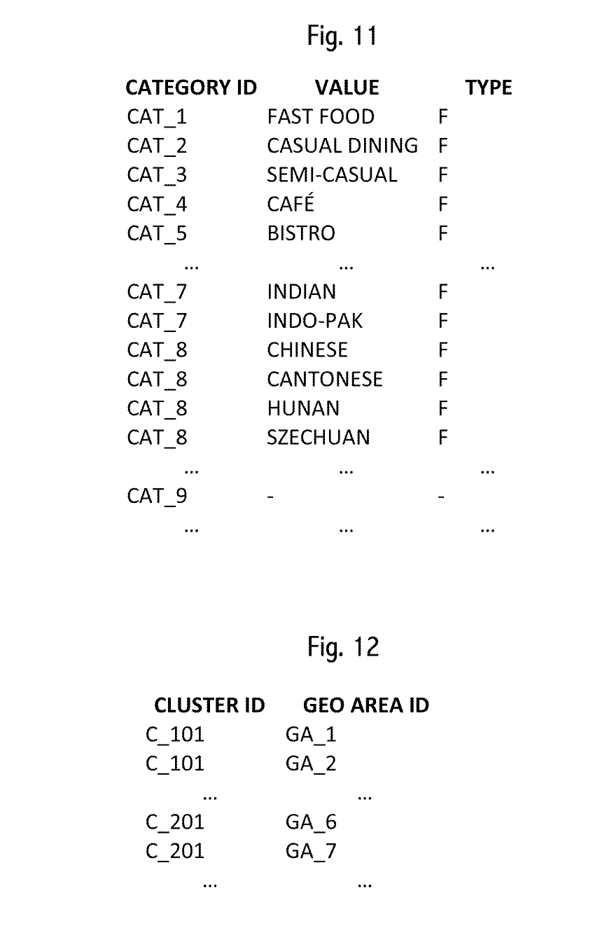

Turning now to FIG. 11, we see a partial, exemplary table showing categories of service types. Column 1 shows and identifier, the category ID, for each category of service. The value, or name, of that service type is in column 2. The type of category service is shown in column 3. In this partial, exemplary table we show type of services that serve food (Type: F). The value column identifies what type of food, such as Indian, or the atmosphere, such as casual. Note that for other service types, such as inside a warehouse, the values or names of the services would be substantially different. A characteristic of food service is the multiple values for a single service point. For example, a service point might serve Indian food in a casual atmosphere. Thus, a single service point may be associated with two categories of service, here, CAT_7 and CAT_2. Note that such a table in practice has additional columns for additional information about service types, as well as additional columns as needed for implementation, tracking, logging, auditing, error management, and the like. Also, such a table in practice has many additional rows to support many more service categories and service types.

Turning now to FIG. 12 we see a partial, exemplary table showing geo locations assigned to clusters. Here, two geo locations, GA_1 and GA_2, shown in column 2, are assigned to cluster ID C_{—} 101, shown in column 1. Similarly, two geo locations, GA_6 and GA_7 are assigned to cluster ID C_{—} 201. Note that such a table in practice has additional columns for additional information about clusters and geo locations, as well as additional columns as needed for implementation, tracking, logging, auditing, error management, and the like. Also, such a table in practice has many additional rows to support many more clusters and geo locations.

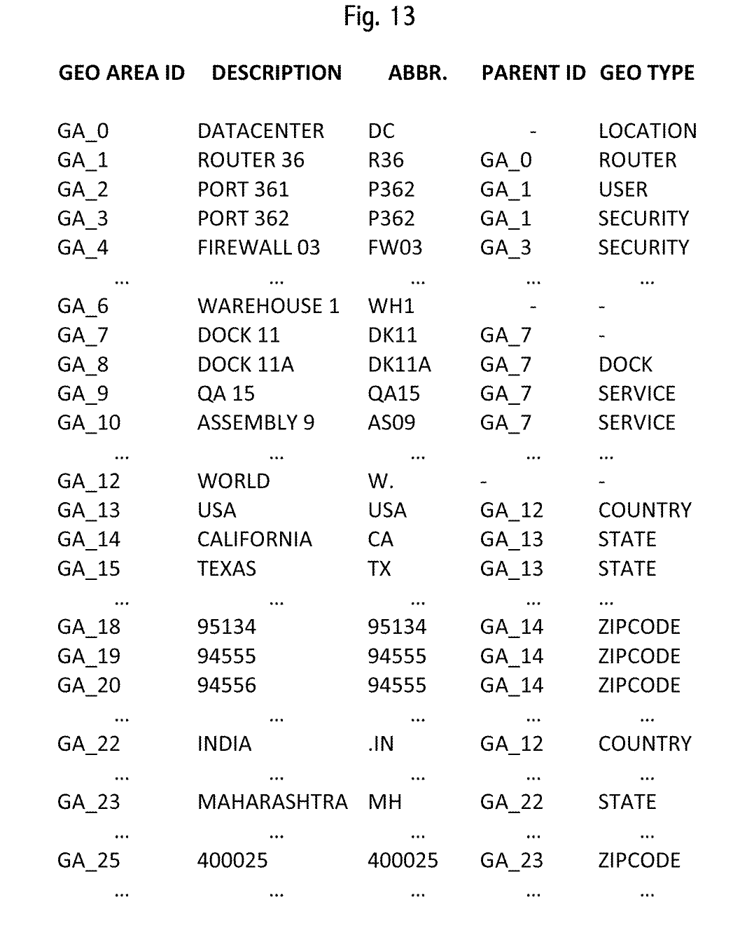

Turning now to FIG. 13, we see a partial, exemplary table showing geo location information. Such a table is critical for holding information about geo locations. The table shows in column one a geo location ID, also called geo area ID. A description of that geo location is in column 2. Note that locations may be political geographic regions, such as countries, zip codes, and the like, are named areas such as shopping malls or a warehouse. They also may be service areas, such as shipping dock. In addition, they may be data service areas, such as data center, equipment room, or an aircraft tracking center. Column 3 shows an abbreviation for the description in that row. Such an abbreviation is helpful with reports and user-interfaces. Column 4 shows a parent geo location ID. This is important because geo locations may be hierarchical. For example, in row 2, for geo location ID GA_1, Router 36 is a geo location under a datacenter, GA_0, shown in row 1. Similarly port 361, GA_2, is a geo location under the router, Router 36, GA_1. The geo location type is shown in column 5. Note that such a table in practice has additional columns for additional information about geo locations, as well as additional columns as needed for implementation, tracking, logging, auditing, error management, and the like. Also, such a table in practice has many additional rows to support many more geo locations.

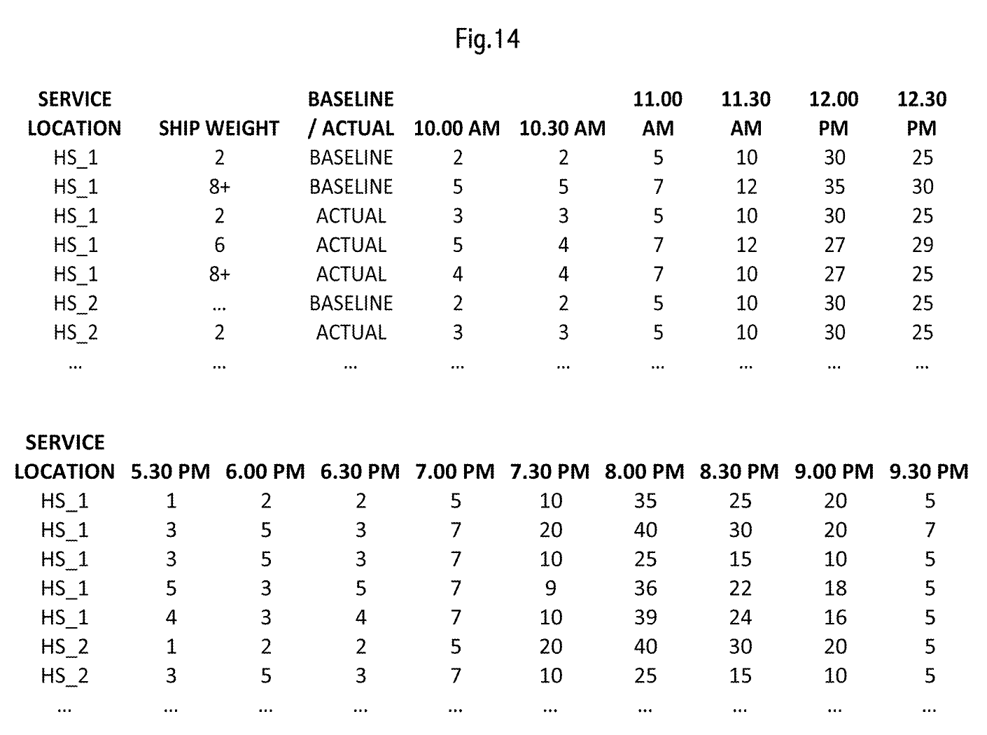

Turning now to FIG. 14, we see a partial, exemplary table showing part of a single baseline queue delay profile for hours of the day. The lower table in the Figure is an extension to the right of the upper table, broken in half in order to fit on the sheet. Note that not all hours of the day are shown. This may be because this service point (HS_1) is unavailable those hours, or may be because only a portion of the table is shown in this Figure. Column 1 shows the service point ID. Column 2 shows an attribute of service objects that might requesting this service. Here, weight categories of packages are shown, such as 2, or 8+. Column three is particularly important for embodiments of this invention. It shows, for the corresponding row, if that row is used to provide queue delay estimates by the embodiment based on the data in the baseline queue profile (“BASELINE”) or to provide queue delay estimates by the embodiment based on real-time data (“ACTUAL.”). See also FIG. 8 for more information on this embodiment. The remaining columns to the right show average queue delay, in the appropriate units, for hours of day (here, in half hour increments per column). For example, in row 2, column 4, we see that for service point HS_1, for packages in weight group 2, that from 10:00 am to 10:30 am there is an average of a 2 minute queue delay, For this same service point, HS_1, for packages in weight category 8+, from 12:00 pm to 12:30 pm there is an average of a 35 minute queue delay; refer to row 2, column 8. Note that variance in queue delay is not shown in the Figure, but is important in some embodiments. This Figure shows a single calendar profile: hours of the day. Not shown are related calendar profiles, such as day of the week, week of the month, month of the year, and special events. However, these other calendar profiles, in any combination, are included in some embodiments. Note that such a table in practice may have additional columns for additional information about service points or service object attributes, as well as additional columns as needed for implementation, tracking, logging, auditing, error management, and the like. In particular, such a table may have information regarding the splitting and merging of timer periods. Also, such a table in practice has many additional rows to support many more geo locations.

FIG. 14 shows a single calendar baseline queue delay profile: hours of the day. Not shown are related calendar profiles, such as day of the week, week of the month, month of the year, and special events. However, these other calendar profiles, in any combination, are included in some embodiments.

Baseline calendar queue delay profiles, that is: baseline queue delay profiles, queue delay profiles, delay profiles, or in context: profiles, in a preferred embodiment are included as part of cluster data. Not all clusters comprise all calendar types of profiles. In addition, in some embodiments, individual geo locations within a cluster have their own baseline queue delay profiles. In addition, some service locations have their own baseline queue delay profiles, although in a preferred embodiment these service location baseline queue delay profiles are stored with or associated with service locations in a master service location table (or comparable data structure), rather than directly associated with a cluster. In some contexts it is useful to think of these baseline queue delay profiles as being in a hierarchy: the cluster level profiles on top, then the geo location profiles, and then at the bottom the service location profiles. In a preferred embodiment, the lowest level profile is used, that is, has priority over, upper level profiles. In alternative embodiments the different profiles may be combined, such as by averaging or weighted averaging.

For all “sets” in claims: embodiments include: “one or more,” “two or more,” “three or more,” “four or more,” set size modifiers are otherwise explicitly stated in the claim.

Ideal, Ideally, Optimum and Preferred—Use of the words, “ideal,” “ideally,” “optimum,” “optimum,” “should” and “preferred,” when used in the context of describing this invention, refer specifically a best mode for one or more embodiments for one or more applications of this invention. Such best modes are non-limiting, and may not be the best mode for all embodiments, applications, or implementation technologies, as one trained in the art will appreciate.

All examples are sample embodiments. In particular, the phrase “invention” should be interpreted under all conditions to mean, “an embodiment of this invention.” Examples, scenarios, and drawings are non-limiting. The only limitations of this invention are in the claims.

May, Could, Option, Mode, Alternative and Feature—Use of the words, “may,” “could,” “option,” “optional,” “mode,” “alternative,” “typical,” “ideal,” and “feature,” when used in the context of describing this invention, refer specifically to various embodiments of this invention. Described benefits refer only to those embodiments that provide that benefit. All descriptions herein are non-limiting, as one trained in the art appreciates.

Embodiments of this invention explicitly include all combinations and sub-combinations of all features, elements and limitation of all claims. Embodiments of this invention explicitly include all combinations and sub-combinations of all features, elements, examples, embodiments, tables, values, ranges, and drawings in the specification and drawings. Embodiments of this invention explicitly include devices and systems to implement any combination of all methods described in the claims, specification and drawings.

1. A method of computing an estimated real-time queuing delay for a queue of first service objects waiting for a first service at a first service point; comprising the steps of:
(a) creating a set of service count records for each of a plurality of geographical regions; wherein each service count record in the set comprises at least one service type and a quantity of that service type for each service type in that geographical region;
(b) executing a clustering algorithm responsive to the sets of step (a); wherein the clustering algorithm generates a plurality of clusters, each cluster comprising service count records;
(c) creating and maintaining, for each cluster, a service point list comprising each available service points within each service count record;
(d) creating and maintaining a service-level baseline queue profile for each service point in the service point lists; wherein the service-level baseline queue profiles comprise historical queue delay data or computed estimated queue delay from historical data;
(e) receiving zero or more real-time queue delay reports generated from the first service point, and aggregating the real-time queue delay reports into a real-time queue delay dataset; wherein the first service point is in a first service point list for a first geographic region from the plurality of geographic regions;
(f) computing a real-time deviation metric of the real-time queue delay dataset using a real-time deviation computation algorithm;
(g) comparing the real-time deviation metric to a real-time deviation threshold;
(h) using either the service-level baseline queue profile for the estimated real-time queuing delay of the first service, or using the real-time queue delay dataset for the estimated real-time queuing delay of the first service, the choice of which responsive to the comparing in step (g); and
(i) repeating steps (e) through (h) for additional real-time queue delay reports generated from additional service points.

2. The method of claim 1, wherein:
in step(b) each cluster in the generated plurality of clusters further comprises a list of geo locations.

3. The method of claim 1, wherein:
The real-time deviation metric is responsive to the service-level baseline queue profile for the first service point.

4. The method of claim 1, wherein:
The real-time deviation metric comprises both a mean queue delay and a variance of queue delay.

5. The method of claim 1, comprising the additional step of:
(j) filtering the real-time queue delay dataset using a first, time-based filtering algorithm;
wherein the filtering step (j) is performed between steps (e) and (f).

6. The method of claim 1, comprising the additional step of:
(k) creating and maintaining a cluster-level baseline queue profile for each service type in each cluster;
wherein the step (k) is performed after step (b).

7. The method of claim 1, comprising the additional step of:
(l) receiving a request for the first service object to receive the first service at any service point within a first geographic region of the plurality of geographic regions;
(m) responding to the received request in step (l) with a first service list of service points within the first geographic region; where each service point in the first service list provides the first service, and wherein each service point in the first service list is located in the first geographic region; and additionally providing for each service in the first service list an estimated real-time queuing delay for that service;
wherein the steps (l) and (m) are performed after step (i).

8. The method of claim 7, wherein:
the request in step (l) occurs prior the first service object entering the queue of service objects.

9. The method of claim 7, comprising the additional step of:
(n) receiving a request for the first service object to receive a second service type within the first geographic region;
(o) searching, using a third-party search service, for all second service types located within a second geographic region with the first geographic region;
(p) responding to the received request in step (n) with a second service list of service points; where each service point in the second service list provides the second service; and additionally providing for each service in the second service list an estimated real-time queuing delay for that service;
wherein the steps (n) through (p) are performed after step (i).

10. The method of claim 9, wherein:
the request in step (n) occurs prior the first service object entering any queue of service objects.

11. The method of claim 1, comprising the additional step of:
(q) receiving a request for the first service object to receive any service within the first geographic region;
(r) responding to the received request in step (q) by providing a sorted third service list of service points within the first geographic region; and additionally providing for each service point in the sorted third service list a service type and a service location of that service point; and additionally providing for each service in sorted third service list an estimated real-time queuing delay for that service;
wherein the steps (q) and (r) are performed after step (i).

12. The method of claim 11, wherein:
the third service list is sorted by the estimated real-time queuing delay of each service point in the third service list.

13. The method of claim 11, wherein:
the request in step (q) occurs prior the first service object entering a service queue.

14. The method of claim 1, wherein:
the real-time queue delay reports are generated by electronics associated with the first service objects.

15. The method of claim 1, wherein:
the real-time deviation metric is a number of standard deviations from the baseline queue profile mean.

16. The method of claim 1, wherein:
the computation of the real-time deviation metric (step (f)) comprise a filtering sub-step wherein outlier data points are deleted.

17. The method of claim 1, wherein:
the baseline queue profile created in step (d) comprises a separate sub-baseline queue profile for each day of the week.

18. The method of claim 17, wherein:
the baseline queue profile created in step (d) further comprises a separate sub-baseline queue profile for each month of the year.

19. The method of claim 17, wherein:
the baseline queue profile created in step (d) further comprises a separate sub-baseline queue profile for each week of the month.

20. The method of claim 1, wherein:
the clusters are created such that geo locations with similar baseline queue profiles are grouped into a cluster.

21. The method of claim 20, wherein:
The baseline queue profiles comprise average waiting times for multiple, distinct periods in a day.

22. The method of claim 21, wherein:
the baseline queue profiles additionally comprise average waiting times for multiple, distinct months of the year.

23. The method of claim 22, wherein:
the baseline queue profiles additionally comprise average waiting times for multiple, distinct weeks of the month.

24. The method of claim 22, wherein:
the queue profiles additionally comprise a variance for multiple, distinct periods in a day.

25. The method of claim 1, wherein the maintaining the service-level baseline queue profile comprises the steps of:
(aa) identifying a first baseline queue profile for a first service point, comprising a set of contiguous time periods, each time period comprising a set of queue profile time period metrics;
(ab) selecting a first time period in the first baseline queue profile;
(ac) dividing the first time period into one or more contiguous sub-time periods;
(ad) receiving two or more real-time queue delay reports for the first service point;
wherein each real-time queue delay report comprises a real-time queue delay for a reporting time in the first time period;
(ae) aggregating the real-time queue delay reports into sub-time period sets, for each sub-time period, wherein the reporting times for each real-time queue delay report in the sub-time period set, are in that sub-time period;
(af) computing, for each sub-time period set, a first statistical metric: a mean, and a second statistical metric: a quantity of set elements, and a third statistical metric;
(ag) waiting until after the end of the first time period, then updating the first baseline queue profile responsive to the first, second and third statistical metrics;
(ah) iterating steps (ab) through (ag) for additional time periods in the first baseline queue profile;
(ai) iterating steps (aa) through (ah) for additional baseline queue profiles for additional service points;
wherein steps (aa) through (ai) are not necessarily performed in the above order.

26. The method of claim 25 wherein the dividing step is performed after the computing step.

27. The method of claim 25 wherein the computing step additionally comprises a weighting factor for each real-time queue delay report wherein the weighting factor is inverse in magnitude to the age of the report.

28. The method of claim 25 wherein the third statistical metric is the variance or standard deviation of queue waiting times.

29. The method of claim 25 comprising the additional step of: filtering a real-time queue delay dataset comprising the step of:
(aj) filtering the real-time queue delay reports, wherein the filtering method comprises the following steps:
(ba) determining a distance (“distance”) between a first location of a first reporting object and the first service point;
(bb) comparing the distance to a predetermined distance threshold;
(bc) receiving one or more real-time queue delay reports for the first reporting object;
(bd) counting the number of times (“a count”), within a predetermined time period, that a real-time queue delay report associated with the first service point, is received from the first reporting object;
(be) comparing the count to a predetermined count threshold;
(bf) optionally assigning a feedback weight inverse in magnitude to the distance;
(bg) accepting or rejecting the one or more real-time queue delay reports responsive to both comparing steps; and
wherein step (aj) is performed between steps (ad) and (ae).

30. The method of claim 25, wherein the maintaining the service-level baseline queue profile comprises the steps of:
(ca) identifying a first baseline queue profile for a first service point, comprising a set of contiguous time periods, each time period comprising a set of queue profile time period metrics;
(cb) identifying one or more split/merge time periods to be used for statistical computations in step (cd);
(cc) selecting a set of time metrics for each split/merge time period;
(cd) computing a statistical mean and variance for each set of time metrics selected for each split/merge time period;
(ce) identifying for the first baseline queue profile, any sub-time period wherein the statistical variance for that sub-time period exceeds a predetermined upper variance threshold; wherein a sub-time period is a contiguous-time-based subset of the split/merge time period;
(cf) dividing each sub-time period so identified in step (ce) into two or more sub-time periods;
(cg) identifying for the first baseline queue profile any tuple of adjacent sub-time periods wherein the statistical mean for the tuple of adjacent sub-times differs by less than a predetermined mean difference threshold; wherein each such sub-time period is one contiguous-time-based subset of the split/merge time period;
(ch) identifying for the first baseline queue profile any tuple of adjacent sub-times wherein the statistical variance for the tuple of adjacent sub-times differs by less than a predetermined variance difference threshold;
(ci) combining tuples of adjacent sub-times responsive to the identifying steps (cg) and (ch); and
(cj) iterating steps (cb) through (ci) for additional baseline queue profiles for additional service points.

31. The method of claim 1, wherein the maintaining the service-level baseline queue profile comprises the steps of:
(ck) identifying a first baseline queue profile for a first service point, comprising a set of contiguous time periods, each time period comprising a set of queue profile time period metrics;
(cl) selecting a first time period in the first baseline queue profile;
(cm) dividing the first time period into one or more contiguous sub-time periods;
(cn) receiving two or more real-time queue delay reports for the first service point;
wherein each real-time queue delay report comprises a real-time queue delay for a reporting time in the first time period;
(co) aggregating the real-time queue delay reports into sub-time period sets, for each sub-time period, wherein the reporting times for each real-time queue delay report in the sub-time period set, are in that sub-time period;
(cp) computing, for each sub-time period set, a first statistical metric: a mean, and a second statistical metric: a quantity of set elements, and a third statistical metric;
(cq) waiting until after the end of the first time period, then updating the first baseline queue profile responsive to the first, second and third statistical metrics;
(cr) iterating steps (cl) through (cq) for additional time periods in the first baseline queue profile;
(cs) iterating steps (ck) through (cr) for additional baseline queue profiles for additional service points;
(ct) wherein steps (ck) through (cq) are not necessarily performed in the above order.

32. The method of claim 1, wherein clustering step (a) uses k-means clustering to partition n geographic regions into k clusters, wherein each of the n geographic regions is a vector of dimensionality d, wherein each element in the vector is a 2-tuple comprising a service type and an associated service type count; and wherein the plurality of clusters in step (b) are the k clusters; and wherein the n geographic regions of this claim are not necessarily the same “plurality of geographic regions” of claim 1.
